(19) United States
(12) Patent Application Publication
(10) Pub. No.: US 2014/0014647 A1
(43) Pub. Date: Jan. 16, 2014

(54) INDUCTION COOKTOP PAN SENSING

(71) Applicants: Daniel Vincent Brosnan, Louisville, KY (US); Gregory Francis Gawron, SR., Louisville, KY (US); John Michael Kulp, JR., Louisville, KY (US); Mingwei Shan, Crestwood, KY (US)

(72) Inventors: Daniel Vincent Brosnan, Louisville, KY (US); Gregory Francis Gawron, SR., Louisville, KY (US); John Michael Kulp, JR., Louisville, KY (US); Mingwei Shan, Crestwood, KY (US)

(21) Appl. No.: 13/547,126

(22) Filed: Jul. 12, 2012

(51) Int. Cl. H05B 6/02

(52) U.S. Cl. 219/600

(57) ABSTRACT

An induction heating system includes an induction heating coil operable to inductively heat a load with a magnetic field; a detector for detecting a current through the coil and providing a current signal representative of the current; and a controller with a memory in communication with a processor. The memory includes program instructions for execution by the processor to detect a presence of the load on the induction heating coil based on a characteristic of the current signal; determine a resonant frequency of the system with the load from a characteristic of the current signal; determine operational performance characteristics of the system; and output an indication of the operational performance characteristics of the system.

### BACKGROUND

The present disclosure generally relates to induction heating, and, more particularly to an induction cook-top apparatus capable of detecting a cooking vessel and relaying induction cooking information to a user.

Induction cook-tops heat conductive cooking vessels and utensils by magnetic induction. An induction cook-top applies radio frequency current to a heating coil to generate a strong radio frequency magnetic field on the heating coil. When a conductive cooking vessel, such as a pan, is placed over the heating coil, the magnetic field coupling from the heating coil generates eddy currents on the vessel. This causes the vessel to heat.

An induction cook-top will generally heat any vessel of suitable conductive material of any size that is placed on the induction cook-top. The power that is delivered to the cooking vessel is important to the user. It is often desirable to maximize this power to reduce cooking time and for precision cooking. It also desirable to optimize the power for energy efficiency and energy savings.

The power that is delivered to the vessel is sensitive to a number of variables including the placement and movement of the vessel, the type of vessel material, the temperature of the vessel, the system input and output power, as well as the system efficiency. Since the user is typically not aware of the effectiveness of their particular induction compatible utensils or vessels, poor cooking performance is typically attributed to the induction cooking system rather than the use of improper cooking vessels or inefficient placement of the vessels on the surface of the cooktop. Many induction cooktop system service calls are related to non-system performance issues. It would be advantageous to be able to provide the user with real-time information related to the effective and efficient use of induction cooking vessels on an induction cooktop.

Accordingly, it would be desirable to provide a system that addresses at least some of the problems identified above.

### BRIEF DESCRIPTION OF THE EXEMPLARY EMBODIMENTS

As described herein, the exemplary embodiments overcome one or more of the above or other disadvantages known in the art.

One aspect of the exemplary embodiments relates to an induction heating system. In one embodiment, the induction heating system includes an induction heating coil operable to inductively heat a load; a detector for detecting a current through the coil and providing a feedback current signal representative of the current; and a controller with a memory in communication with a processor. The memory includes program instructions for execution by the processor to detect a presence of the load on the induction heating coil based on a characteristic of the feedback current signal; determine a resonant frequency of the system with the load from a characteristic of the feedback current signal; determine operational performance characteristics of the system from the characteristic of the current feedback signal; and output an indication of the operational performance characteristics of the system.

Another aspect of the exemplary embodiments relates to a method. In one embodiment, the method includes monitoring a sensor signal of an induction heating apparatus, the sensor signal corresponding to a current through a high frequency power source of the induction heating apparatus, detecting a presence of a load on the induction heating apparatus from the sensor signal, detecting an amount of power coupled into the load from the sensor signal, and providing an indication of the amount of power that is coupled to the load.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and unless otherwise indicated, they are merely intended to conceptually illustrate the structures and procedures described herein. In addition, any suitable size, shape or type of elements or materials could be used.

### BRIEF DESCRIPTION OF THE DRAWINGS

In the drawings:

FIG. 1 shows a schematic block diagram of an induction heating system according to an embodiment of the present disclosure;

FIG. 2 shows a power vs frequency curve for an induction heating system according to the aspects of the disclosed embodiments.

FIG. 3 shows a schematic diagram of an induction heating system according to an embodiment of the present disclosure;

FIGS. 4 and 5 are graphs illustrating exemplary non-resonant and resonant current feedback signal signatures in an induction heating system according to an embodiment of the present disclosure.

FIGS. 6-8 are graphs illustrating exemplary pulse width modulated signals for various states of an induction heating system according to an embodiment of the present disclosure.

FIG. 9 is a table illustrating exemplary efficiency values relative to duty cycles of signals corresponding to operational states of the system of the disclosed embodiments.

FIG. 10 is a block diagram of input current calculation in an induction heating system according to an embodiment of the present disclosure.

FIG. 11 is a three-dimensional representation of maximum input power at resonance, or 20 KHz whichever the system reaches first when moving down in frequency, as a function of pan resistance and coil inductance in an induction heating system according to an embodiment of the present disclosure.

FIG. 12 is a flowchart illustrating an exemplary process according to an embodiment of the present disclosure.

### DETAILED DESCRIPTION OF THE EXEMPLARY EMBODIMENTS OF THE DISCLOSURE

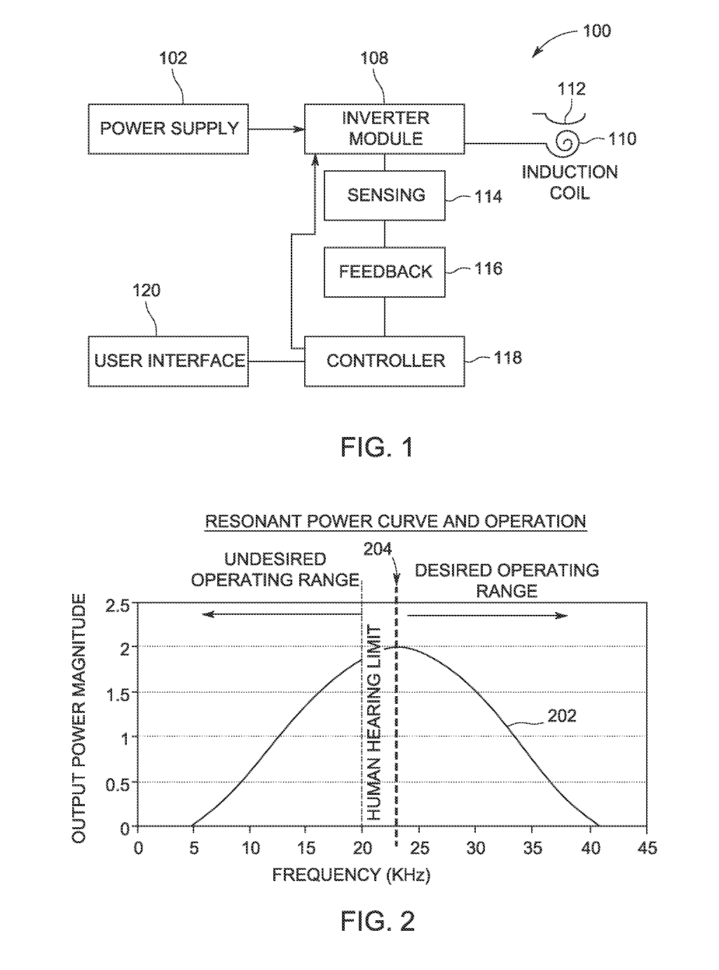

FIG. 1 is a schematic block diagram of an induction heating system 100 according to one embodiment of the present disclosure. The aspects of the disclosed embodiments are generally directed to detecting and optimizing the amount of power being delivered to a cooking vessel or utensil on a surface or cooktop of an induction heating system and relaying induction cooking information to the user. It will be understood that use of the term “cooking vessel” or “utensil” herein is merely exemplary, and that term will generally include any object or load of a suitable type that is capable of being heated by an induction heating coil. For purposes of the description herein, the term “pan” will be used to refer to any cooking vessel or utensil that can be used with an induction heating system. The aspects of the disclosed embodiments are directed to determining information such as system efficiency, power delivery, pan quality, effects of pan movement/disturbances, power sharing and multi-pan audio tests, and relay that information to the user. The user can then optimize the operation of the system 100 using this information.

As shown schematically in FIG. 1, in one embodiment, the induction heating or cooking system 100 generally includes a source of AC power 102, which may be a conventional 50/60 Hz, 120/240 volt AC supplied by utility companies. The power source 102 also includes a conventional rectifier circuit for rectifying the power signal to provide a rectified power signal to resonant inverter module 108. The resonant inverter module 108 drives the induction heating coil 110 with high frequency current. This creates a magnetic field, which is magnetically coupled into the cooking vessel 112. The magnetic coupling, also referred to as eddy currents, inductively heats the pan 112 or other object placed on, over or near the induction heating coil 110.

The output power that is delivered to the induction coil 110 is generally a function of the input power signal (in particular, the level and frequency of the current supplied to the coil), the inductance of the induction coil 110, the resistance of the pan 112, and the resonant frequency of the system 100. The closer the system 100 is driven to the resonant frequency, the more efficiently power that can be delivered to the system 100. The maximum power output of the system 100 occurs at resonance and subsequently lower desired power levels are driven away from resonance accordingly. However, the system 100 is generally not operated below approximately 20 kilohertz, as this is in the human audible frequency band, and the inverter module 108 will have a tendency to “sing” at the drive frequency, which can be considered annoying.

The frequency of the current supplied to the induction coil 110 by inverter module 108 and hence the output power of the induction coil 110 is controlled by controller 118 which controls the switching frequency of the inverter module 108. The controller 118 generally includes, is coupled to or is in communication with, one or more processors that are operable, inter alia, to determine and monitor the power being delivered to the pan 112. In one embodiment, the controller 118 comprises a processing device and includes machine-readable instructions that are executable by the processing device.

The system 100 also includes a user interface 120 that is operatively connected to the controller 118. The user interface 120 can be integrated with the induction heating system 100, or located remotely from the induction heating system 100. In one embodiment, the user interface 120 can be coupled to the controller via a network or a wireless connection. The user interface 120 is generally configured to communicate information to the user and allow the user to provide commands and instructions to the system 100, such as a power level desired to be delivered to the pan 112. The user interface 120 can include various sensory input and feedback devices, including for example knobs, buttons, touchkeys, displays, meters, gauges, indicators, speakers, chimes and buzzers. Displays can include for example, liquid crystal display(s), touch screen display(s) or near touch display(s). Indicators can include lights, light emitting diode (LED) indicators, vacuum fluorescent displays (VFD's), organic light emitting diodes (OLED) and other discrete lighting and indicator devices. It is a feature of the disclosed embodiments to relay induction cooking related information to a user.

In one embodiment, the user interface 120 enables the user to establish the power output of the heating coil by selecting a power setting from a plurality of user selectable settings. A current detector in the form of a sensor circuit 114 senses the current supplied to the heating coil 110 by the inverter circuit 108. The sensor circuit 114 generally produces a signal representative of the current through a current transducer or a resistive shunt. The sensor circuit 114 is generally configured to produce a voltage output that is representative of the current flowing through the inverter circuit 108. The feedback circuit 116 is configured to amplify and condition the output from the sensor circuit 114 before sending it to the controller 118. Controller 18 processes the signal from feedback circuit 116 to generate information related to the current magnitude, pan presence, and proximity of the system to resonance (full power). For example, in one embodiment, the characteristics of the output signal from the feedback circuit 116 are analyzed across a frequency spectrum as is disclosed in commonly owned U.S. patent application Ser. No. 13/154,190 (GE 242578-1 US) entitled “INDUCTION COOKTOP PAN SENSING”, filed on Jun. 6, 2011, the disclosure of which is incorporated herein by reference in its entirety. The characteristics of the signal from the feedback circuit 116 are used to determine the presence of a pan 112 on the induction coil 110, as well as the size and type of pan and the resonant frequency of the power circuit with the pan 112 present.

In one embodiment, the controller 118 is operative to control the frequency of the power signal generated by inverter module 108 to operate the induction coil 110 at the power level corresponding to the setting selected by the user via the user interface 120. The controller 118 processes and analyzes the output from the feedback circuit 116 to determine, inter alia, the presence of a pan 112 on the induction coil 110, a size and type of the pan 112 and the appropriate frequency of the power circuit to drive the induction heating coil 110 at the user selected power setting. The controller 118 is configured to control power to the induction coil 110, which can include turning the power off, based on the determined size and type of pan 112, or lack thereof.

FIG. 2 illustrates one example of a power versus frequency curve 202 for the induction cooking system 100. Depending upon the interaction of the induction coil 110 and pan 112, as well as the system capacitance, the resonant frequency or point, indicated by line 204, will shift left or right. However, the general shape of the curve 202 will always be the same. One process for determining the resonant frequency of an induction resonant inverter is described in commonly owned U.S. patent application Ser. No. 12/841,247 (GE 244638-1 US) entitled “RESONANT FREQUENCY DETECTION FOR INDUCTION RESONANT INVERTER”, filed on Jul. 22, 2010, the disclosure of which is incorporated herein by reference in its entirety.

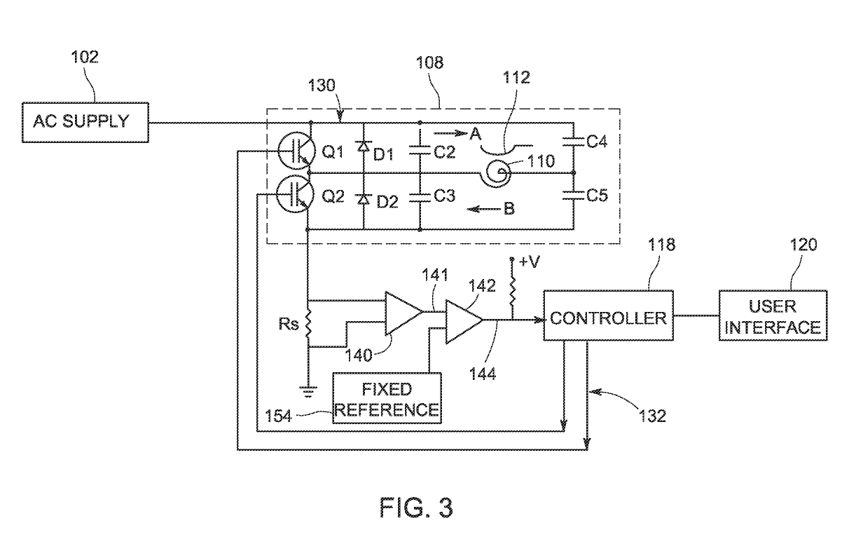

FIG. 3 illustrates one embodiment of an exemplary circuit diagram for the system 100 shown in FIG. 1. The circuit elements and connections shown in FIG. 3 are merely exemplary, and in alternate embodiments, any suitable circuit elements can be utilized.

As is shown in FIG. 3, the induction system 100 comprises a power supply input device 102, as will generally be understood in the art. The resonant inventor module 108 is provided with switching devices Q1 and Q2, such as for example transistors, which provide power to the load, which in this example comprises the induction coil 110, and, if present, the pan 112 shown in FIG. 1. The controlled switching of the induction coil 110 provides high frequency current from the power supply 102. The directions indicated by A and B, are the directions of the current flow through the induction coil 110, as controlled by the switching of devices Q1 and Q2. In one embodiment, the controller 118 includes or is operatively coupled to a switching unit that provides the controlled switching of the devices Q1 and Q2 based on one or more switching control signals 132 from the controller 118. In one embodiment, the devices Q1 and Q2 are insulated-gate bipolar transistors (IGBT) and the switching unit 130 is a pulse width modulation (PWM) controlled half bridge gate driver integrated circuit. In alternate embodiments, any suitable switching device can be used, other than including IGBT's. As shown in FIG. 3, snubber capacitors C2, C3, and resonant capacitors C4, C5 are connected between a positive power terminal and a negative power terminal to successively resonate with the induction heating coil 110. The induction heating coil 110 is connected between the switching devices Q1 and Q2, and induces an eddy current into the pan 112, shown in FIG. 1, by using the magnetic field generated by current flowing through the coil. The eddy currents heat the pan 112, as is generally understood in the art.

In one embodiment, switching of switching devices Q1 and Q2 occurs at a switching frequency in a range that is between approximately 20 kilohertz to 50 kilohertz (kHz). The low end of the spectrum should be high enough to avoid a potentially annoying audible hum. A range on the order of 20-50 kHz, satisfies this criterion and has been found to provide satisfactory results.

When transistor Q1 is triggered on (and Q2 is off) positive voltage is applied to the heating coil 110. When transistor Q2 is triggered on (and Q1 is off) negative voltage is applied to the induction heating coil 110. This application of voltage will induce a current through the induction coil 110 in either direction A or B. When current opposes the applied voltage the reverse diode D1 or D2 in parallel with the activated transistor Q1 or Q2 is conducting current. When current does not oppose the applied coil voltage the activated transistor Q1 of Q2 is conducting current. This allows continuous alternating current to flow through the coil while discontinuous current flows through the transistors Q1 and Q2 and reverse diodes D1 and D2.

When the induction inverter 108 is running, capacitors C4 and C5, and the induction coil 110 (including any load thereon), form a resonant circuit. The resonant frequency is generally defined by the equation:

fresonant=1÷(2π\sqrt{L2C})

The current feedback signal 141 is a conditioned feedback signal representing the voltage across the shunt resistor Rₛ, which is related to the current flowing through the induction inverter 108.

There are two signals that are primarily used to control and provide the feedback from the feedback circuit 116 to the induction cooktop system 100 shown in FIG. 1. One is the current feedback signal 141 shown in FIG. 3 and the other is a pulse width modulation signal 144. The sensing circuit 114 and the feedback circuit 116 of FIG. 1 generate the current feedback signal 141 as illustrated in FIG. 3. In this example, the current sensing circuit 114 and feedback circuit 116 comprises the shunt resistor Rₛ, the operational amplifier 140 and the comparator 142. The shunt resistor Rₛ is connected in series with the inverter circuit 108 in the return current path. The voltage across Rₛ is input to the operational amplifier 140, which buffers the signal. The operational amplifier 140 is generally configured to provide a signal 141 which is a conditioned representation of the current through coil 110.

As shown in FIG. 3, the current feedback signal 141 is sent to the input of the comparator circuit 142. The comparator circuit 142 is generally configured to create the pulse width modulated average signal (PWM Average) 144 that is based on how much of the current feedback signal 141 is above or below a reference point, or reference signal 154. The reference point is typically the equivalent of approximately zero amperes through the shunt resistor Rₛ.

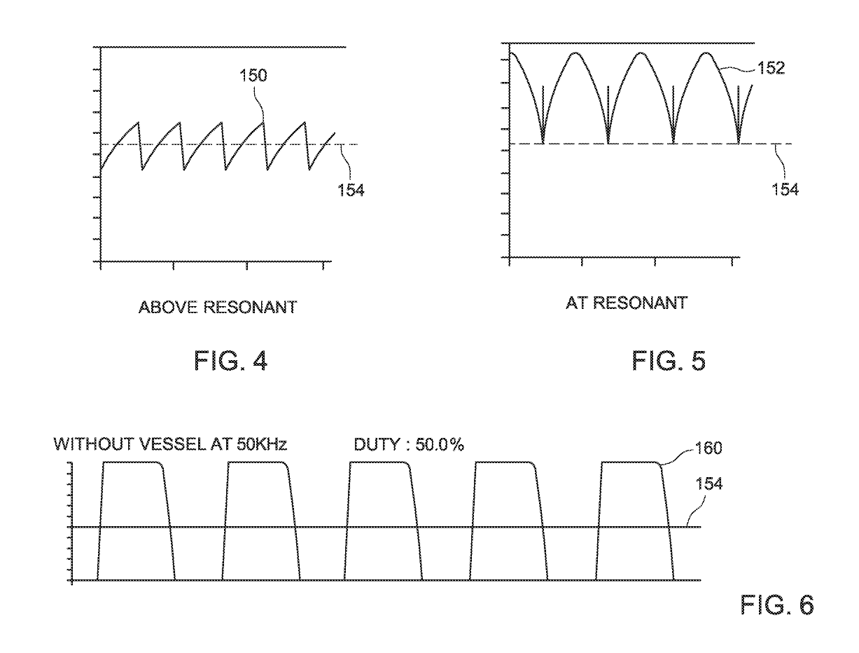

FIGS. 4 and 5 illustrate examples of the current feedback signal 141 of FIG. 3 for various system states. In FIG. 4, the waveform 150 illustrates an example of the current feedback signal 141 when the system 100 is operating above its resonant frequency. The waveform 152 in FIG. 5 illustrates an example of the current feedback signal 141 when the system 100 is operating at substantially its resonant frequency. Both signals 150, 152 are portrayed relative to the fixed reference signal 154.

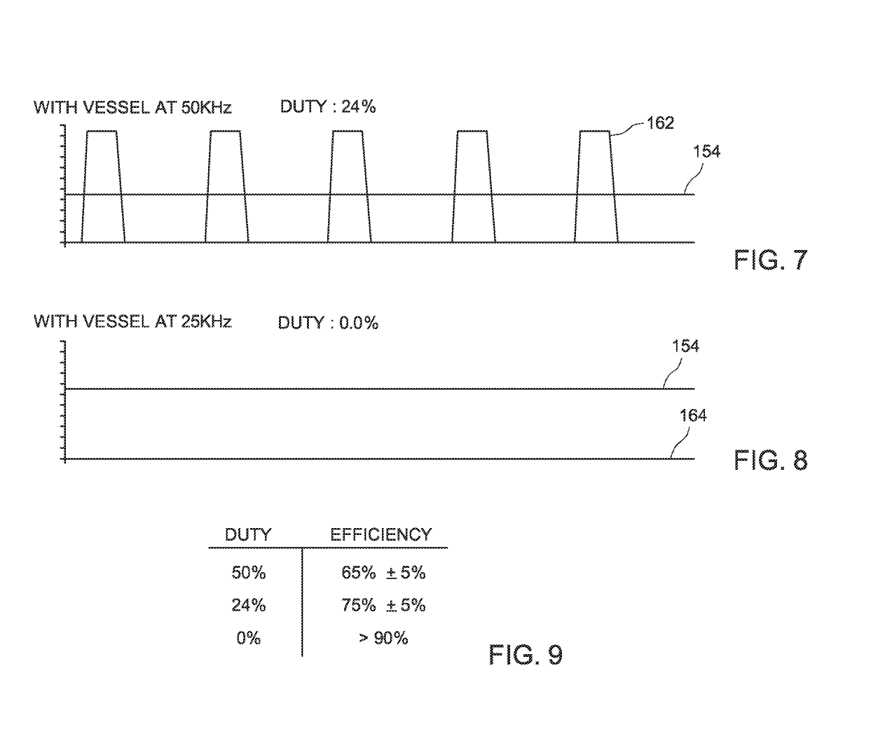

FIGS. 6-8 illustrate various representations of the PWM Average signal 144 for various states of the system 100. Referring to FIG. 6, the square wave designated 160 is the output 144 (FIG. 3) of the comparator circuit 142 that compares the current feedback signal 141 to the fixed reference signal 154. In FIG. 6, the system 100 is operating without the pan 112, at a frequency of approximately 50 kHz. In FIG. 7, the signal 162 illustrates the system 100 operating with a pan 112 on the induction heating coil 110, at a frequency of approximately 50 kHz. In FIG. 8, the signal 164 illustrates the system 100 operating with a pan 112, at a frequency of approximately 25 kHz. From these signals, many determinations can be made about the operation of the system including, determining the system input power, the system output power, the system efficiency, the presence of a pan 112, the ability of the pan 112 to achieve full power, whether the pan 112 is shifting or moving, the optimal placement of the pan 112, whether an audible noise will be generated by the cooktop, and what power sharing might be necessary when multiple coils 110 are in use.

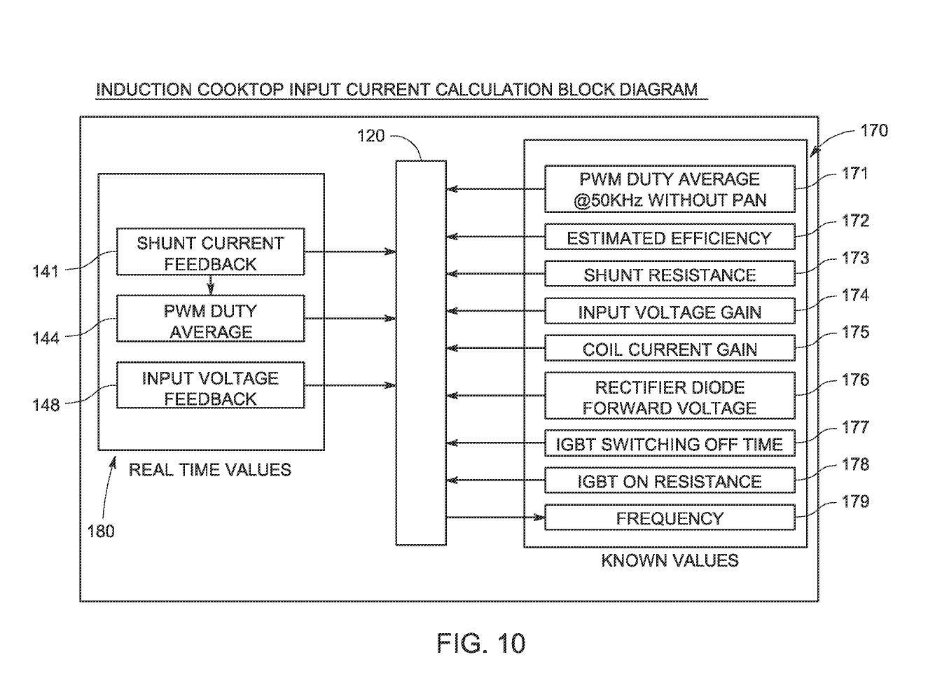

FIG. 9 is a table illustrating the efficiency of the signals 160, 162 and 164, relative to the respective duty cycles of the signals. The proximity of the operating frequency of the system to the resonant frequency of the system 100 is a measure of efficiency. The efficiency can be measured by examining the current feedback signal 141 with the waveforms shown in FIGS. 4 and 5 and/or the PWM Average signal 144 of FIGS. 6-8. As the system operating frequency approaches the resonant frequency, the duty cycle of the signal 144 at the output of comparator 142 approaches zero. For example, in one embodiment, the PWM average signal 144 is equated with an efficiency (%) value where the lower the PWM Average number the higher the efficiency. An example of this is shown in the table of FIG. 9, relating to FIGS. 6, 7 and 8. In FIG. 6, the duty cycle of the signal 160 is approximately 50%, and the associated efficiency is approximately 65%. In FIG. 7, the duty cycle of the signal 162 is approximately 24%, and the corresponding efficiency is approximately 75%. In FIG. 8, the duty cycle of the signal 160 is approximately 0%, the corresponding efficiency is greater than approximately 90%. FIG. 10 illustrates a block diagram of one embodiment of the parameters of the system 100 used in the input current calculation. As is shown in FIG. 10, the known operating values 170 of the system 100 are used by the controller 118 to calculate the real time system operating values 180. The known values 170 can include, for example the PWM Average signal at 50 kHz without the pan 171, the estimated efficiency 172, the shunt resistance Rₛ 173, the input voltage gain 174, the coil current gain 175, the rectifier diode forward voltage 176, the IGBT switching off time 177, the IGBT on-resistance 178 and the frequency 179. The real time operating values 180 include the shunt current feedback 141, the PWM Average 144 and the input voltage feedback 148.

Similarly to the input power, the output power is known to the system 100. The amount of power being delivered to the pan 112 can be similarly presented or displayed to the user.

Knowing the input and output power allows for the calculation of the system efficiency. Generally efficiency is defined as the ratio of the output power to the input power. The controller 118 can determine the efficiency and present the efficiency information to the user.

In one embodiment, the efficiency of the system can be indicative of the quality of the load. For example, while operating the induction heating coil at an operational frequency, an amount of power coupling to the load at the operational frequency can be determined. The quality of the load is determined from a difference between the amount of power coupled to the load at the operational frequency and a maximum output power of the system, which is also related to the efficiency. This process could be carried out for example, during a test mode of the system. For example, a user wishing to test the quality of a specific cookware could utilize these features by entering the test mode of the system 100. After entering the test mode, the system 100 would prompt the user to place the cookware, such as the pan 112 on the induction coil 110. The system 100 would achieve a test frequency and derive input power, output power, and system efficiency rapidly. The user would then receive a feedback indication as to the quality of the pan 112. For example, if the user were to place an aluminum pan with little ferrous material composition, the system 100 would detect a low level of efficiency and report to the user that the selected pan is not suitable for induction cooking. Conversely if a user were to place a cast iron pan with significant ferrous content the system 100 would detect a higher efficiency level and report that the pan is adequate for induction cooking. Alternately, if the user wanted real time feedback while cooking, in one embodiment, the test mode could be accessed during normal cooking what would allow continuous feedback related to the quality and efficiency of cooking, which can change as a function of temperature, pan placement, and pan movements.

Table 1 below illustrates the efficiencies for all possible theoretical pans having resistance which together with the resistance of the induction coil present a load resistance in the range of, and including 0 to 8 ohms and a resultant inductive load (coil and pan) in the range of, and including, 20 to 100 microHenries, that would result if the system 100 is run at full power, i.e. at its resonant frequency or at 20 kHz if the resonant frequency happens to fall below 20 kHz.

TABLE 1

| | | EFFICIENCY | | | | | | | | |
|---|---|---|---|---|---|---|---|---|---|---|
| PAN RESISTANCE | 8 Ω | 0.976093 | 0.974744 | 0.972584 | 0.971841 | 0.969655 | 0.977885 | 0.982771 | 0.979814 | 0.97828 |
| (OHMS) | 7 Ω | 0.975301 | 0.973494 | 0.916714 | 0.975831 | 0.967133 | 0.978089 | 0.978954 | 0.978918 | 0.976594 |
| | 6 Ω | 0.973972 | 0.973465 | 0.971846 | 0.975954 | 0.964192 | 0.97584 | 0.977121 | 0.976553 | 0.97434 |
| | 5 Ω | 0.971979 | 0.971116 | 0.941203 | 0.977052 | 0.959129 | 0.974427 | 0.975072 | 0.972571 | 0.969979 |
| | 4 Ω | 0.968484 | 0.969654 | 0.968585 | 0.968938 | 0.960526 | 0.971164 | 0.970053 | 0.967324 | 0.964534 |
| | 3 Ω | 0.961249 | 0.963588 | 0.961683 | 0.954631 | 0.961662 | 0.965918 | 0.96234 | 0.959144 | 0.954611 |
| | 2 Ω | 0.951286 | 0.959783 | 0.956364 | 0.94315 | 0.948147 | 0.951866 | 0.918674 | 0.94224 | 0.968908 |
| | 1 Ω | 0.917255 | 0.918412 | 0.919071 | 0.910756 | 0.906366 | 0.910567 | 0.906997 | 0.89624 | 0.885526 |
| | 0 Ω | 0.001789 | 0.001789 | 0.001734 | 0.001731 | 0.001737 | 0.001844 | 0.010413 | 0.016601 | 0.009804 |
| | | 20 | 30 | 40 | 50 | 60 | 70 | 80 | 90 | 100 |

Coil Inductance (uH)

One aspect of the disclosed embodiments provides for a determination of pan quality. “Pan Quality” as the term is used herein, generally refers to the amount of power that can be delivered to a pan 112. A high quality pan 112 will generally accept the maximum wattage the system 100 can deliver. One example of such a system can deliver approximately 3700 watts, less any losses or inefficiencies. A lower quality pan 112 will tend to accept only a lesser amount of power.

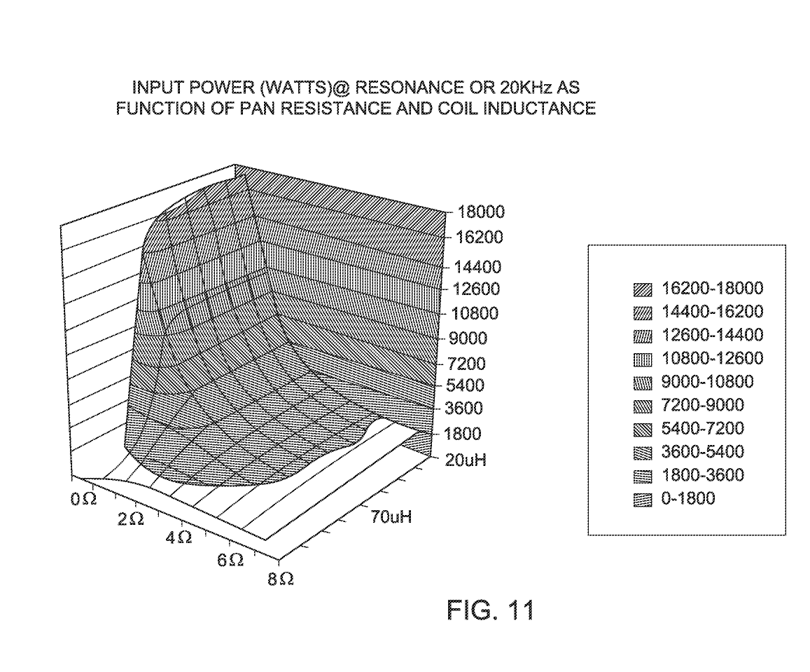

To check pan quality, in one embodiment, the inverter system 100 is activated, the presence of the pan 112 is determined as is the input and/or output power that is being delivered at the resonance that the pan 112 imposes on the system 100. FIG. 11 is a three-dimensional plot illustrating maximum input power at resonance, or 20 KHz, whichever the system 100 reaches first when moving down in frequency, as a function of the resistance and inductance of the load presented by the combination of pan and coil for a substantially all-inclusive range of possible pans 112 in an induction heating system according to an embodiment of the present disclosure. As is shown in FIG. 11, the type of pan 112 will directly affect the maximum potential power.

The pan quality feature allows the user to place a pan 112 on the induction coil 110 and received feedback as to how “compatible” the pan 112 is. Factors such as the pan material, size, flatness can affect how much of the magnetic field generated by the induction coil 110 can be coupled into the material for cooking. The ability of the pan to couple more of the magnetic field is an indication of the compatibility of the pan. In one embodiment, an optimal placement of the load on the induction heating coil can generally be identified by determining the position of the load on the induction heating coil where the maximum amount of power is coupled to the load. In this embodiment, the position of the load on the induction heating coil is detected. The amount of power that is coupled to the load at each detected position is determined. The calculated efficiency, which can be determined in the test mode for example, could be compared to a set of pre-determined efficiency ranges related to for example, poor/medium/good pans or even more simply a cutoff value that states the pan is acceptable (compatible) or not. In one embodiment, the cutoff value could be for example, 70% at Full power.

In one embodiment, the load on the induction heating coil is detected in multiple positions, such as a first position and a second position. This process can be carried out, for example, during the test mode described above. The amount of power coupling to the load at each of the first and second positions is determined and can be indicated. A comparison is made of the amount of power coupling to the load at each of the first and second positions to determine the position where the maximum amount of power is coupled to the load. This position is indicated as the optimal placement position. Although only two positions are described in this example, in alternate embodiments, any suitable number of positions can be used to determine the optimal load placement position on the induction heating coil.

The power and position information can be relayed to the user via the user interface 120. In one embodiment, the information can be in the form of a binary check such as a red or green light, where red indicates a less compatible pan and green indicates a more compatible pan 112. In alternate embodiments, any suitable indicator can be used, such as for example, a gauge or meter, a number or percentage score (e.g., 1-10), or an audio indication.

Movement or shifting of the pan 112 on the induction coil 110 will also affect the amount of power that is coupled into the pan 112. In one aspect of the disclosed embodiments, the system 100 will monitor such things as output power, input power and efficiency, while the pan 112 is being moved, to allow the system 100 to accurately determine where the optimal placement of the pan 112 on the coil 110 is. This feature allows the user to determine the optimal location on the burner for cooking. This can include for example, centered for the most power and most heating, or off-center for lesser heat. The information as to the placement, movement or shifting of the pan 112 on the induction coil 110 can be displayed to the user in any suitable fashion through the user interface 120. The information can be displayed as part of a one-time test mode, or in real time. For example, in one embodiment, the information is displayed to the user in real time and can include how much power is being delivered as well as power input, power output and efficiency, while the pan 112 is being shifted in order to determine optimal placement. In one embodiment, the controller 120 is configured to process the power input, power output and efficiency information while the pan 112 is being shifted and provide the user with an indication of the optimal placement of the pan 112.

As a pan 112 is shifted about the induction coil 110, the induced system resistance and inductance will vary. The input power can be measured at either the source directly or looking purely at the output and making some calculations and assumptions given what is known about the operating state of the system 100. When the input power to the system 100 is known, the amount of power consumed by the system 100 can be displayed. This can include a true wattage reading, one or more LED indicators, or an audible indication that indicates the various power conditions for the input of the system 100. The amount of power consumed can be presented as part of a test mode or in real time while cooking.

In one embodiment, the system 100 can include more than one induction coil 110. However, the total amount of power that the system 100 can deliver at one time is limited. Thus, in a situation where multiple induction coils 110 need to be run at substantially the same time, there can be a need to limit or alter the amount of power delivered to maintain the system 100 within an acceptable region. Here again, this information can be calculated by the controller 118 and presented to the user via the user interface 120. In one embodiment, a meter is provided for each induction coil 110 that indicates a percentage value of the total power being consumed by the respective induction coil, where a total value for each coil adds to 100%.

In one embodiment, the system 100 can generate audio tones from multiple pans 112 on the cooking surface. When running multiple pans for cooking, the system 100 can cause the pans 110 to “sing” a song. In one embodiment, the audible noise generated by the system 100 is based on the heterodyne frequency between any two burners. For example, where the first burner is operating at 20 kHz and the second burner is operating at 25 kHz, the resulting audible noise generated is 25 kHz−20 kHz=5 kHz. This can be used to play tones, or multiples of tones of interest.

By analyzing the characteristics of the feedback signal 141 across a frequency spectrum, the disclosed embodiments can determine whether a cooking vessel is present on the induction heating coil 110, the size and type of the cooking vessel and the appropriate frequency required to drive the induction heating coil 110 at the user selected power setting. Also, operating at the resonant frequency is key to the optimal amount of power transfer from the induction coil 110 to the vessel 112 shown in FIG. 1. Analysis of the feedback signal 141 as a function of switching frequency can also be used to detect the resonant frequency of the system 100 with a vessel in position for heating.

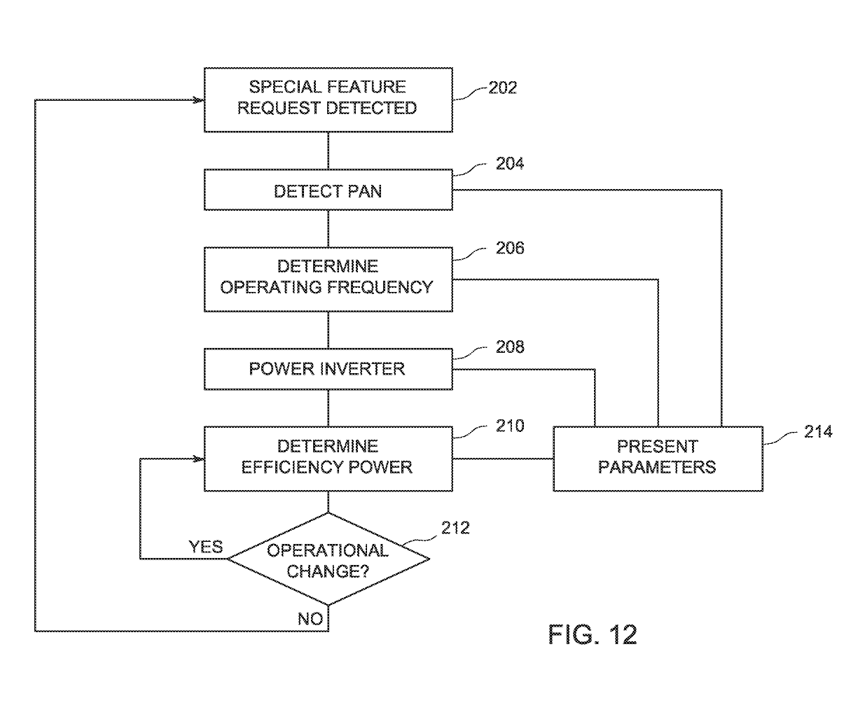

FIG. 12 illustrates an exemplary process flow for an induction cooking system 100 incorporating aspects of the disclosed embodiments. In one embodiment, the entry of a special feature request is detected 202. The special feature request generally relates to a user request for cooking information in real time, which can include, for example, system efficiency information, power delivery, pan quality, effect of pan movement/disturbances, power sharing and the multi-pan audio test. In one embodiment, entering a special feature request can also including setting the burner power to a desired power level either before or after making the request. The presence of a pan 112 on the induction coil 110 is detected 204. In one embodiment, the controller 118 determines 206 the operating frequency of the inverter module 108 with the pan 112. The inverter module 108 is powered 208 and the efficiency is determined 210. If an operational change is made, such as movement of the pan 112 on the induction coil 110, which causes a change in the resonant frequency, the input and output power values, as well as the efficiency, can once again be reevaluated and determined 210. This allows the optimum placement of the pan 112 on the induction coil 110. In one embodiment, one or more of the determined values, such as pan quality, effect of pan shifting/movement, input power, output power, system efficiency, power sharing and audio noise generation can be presented 214 to the user. This can include visual, audio, and audio-visual presentment.

The aspects of the disclosed embodiments allow the system 100 to be operated normally while cooking, but allow the user to cycle through and choose the various type of special feature feedback they desire. Thus, the user sets a burner to a certain power level, begins cooking and during cooking can change the feedback type, which is typically a standard power level, to features such as True Wattage Reading, Efficiency, Pan Quality, and Power Sharing between burners.

For example, if special feature selected is the pan quality feature, the controller 118 determines the presence of the pan 112 on the inverter 110. One exemplary process of determining the presence of a pan 112 on the inverter is disclosed in the afore mentioned commonly owned U.S. patent application Ser. No. 13/154,190 (GE 242578-1 US) entitled “INDUCTION COOKTOP PAN SENSING”. The controller 118 can determine what input power and/or output power is being delivered at the resonance that the pan 112 imposes on the system.

In one embodiment, if the special feature request is a Pan Placement feature, the controller 118 is configured to determine the amount of power that is coupled to the pan 112 as the pan 112 is moved or shifted over the induction coil 110. The controller 118 can provide the user with feedback as to the amount of power being coupled to the pan 112 as it is moved to allow for determining the optimal placement. Although the special features are generally described herein as be determined during cooking, in one embodiment, the system 100 can include a test or set-up mode, where the determination is made prior to or separate from a cooking process.

The aspects of the disclosed embodiments may also include software and computer programs incorporating the process steps and instructions described above that are executed in one or more computers. In one embodiment, one or more computing devices, such as a computer or the controller 114 of FIG. 1, are generally adapted to utilize program storage devices embodying machine readable program source code, which is adapted to cause the computing devices to perform the method steps of the present disclosure. The program storage devices incorporating features of the present disclosure may be devised, made and used as a component of a machine utilizing optics, magnetic properties and/or electronics to perform the procedures and methods of the present disclosure. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

The computing devices may also include one or more processors or microprocessors for executing stored programs. The computing device may include a data storage device for the storage of information and data. The computer program or software incorporating the processes and method steps incorporating features of the present disclosure may be stored in one or more computers on an otherwise conventional program storage device.

The aspects of the disclosed embodiments will detect a vessel, such as a pan, on an induction heating coil, and determine features related to the induction cooking system. These features include system efficiency, power delivery, pan quality, effect of pan movement and disturbances, power sharing and multi-pan audio tests. The information and data related to the features can be gathered as part of a one-shot test mode or in real-time, while cooking. The information can also be presented to the user in a suitable form, through a user interface and can include visual and audible feedback.

Thus, while there have been shown, described and pointed out, fundamental novel features of the invention as applied to the exemplary embodiments thereof, it will be understood that various omissions and substitutions and changes in the form and details of devices illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto

What is claimed is:

1. An induction heating system comprising:
an induction heating coil operable to inductively heat a load with a magnetic field;
a detector for detecting a current through the coil and providing a feedback current signal representative of the current; and
a controller with a memory in communication with a processor, the memory including program instructions for execution by the processor to:
detect a presence of the load on the induction heating coil based on a characteristic of the feedback current signal;
determine a resonant frequency of the system with the load from a characteristic of the feedback current signal;
determine an operational performance characteristic of the system; and
output an indication of the operational performance characteristic of the system.

2. The system of claim 1, wherein the memory further includes program instructions for execution by the processor to:
detect a first position of the load on the induction heating coil;
determine an amount of power coupling to the load at the first position; and
output an indication of the amount of power coupling to the load at the first position.

3. The system of claim 2, wherein the memory further includes program instructions for execution by the processor to:
detect a second position of the load on the induction heating coil;
determine an amount of power coupling to the load at the second position;
compare the amount of power coupling the load at the first position to the amount of power coupling to the load at the second position; and
output an indication of the comparison.

4. The system of claim 2, wherein the memory further includes program instructions for execution by the processor to:
detect the load in multiple positions on the induction heating element; and
compare the amount of power coupled to the load in each position;
determine an optimal position of the load on the induction heating coil, the optimal position corresponding to a position where a maximum amount of power is coupled to the load; and
output an indication of the optimal position.

5. The system of claim 1, wherein the memory further includes program instructions for execution by the processor to:
operate the system at an operational frequency;
determine an amount of power coupling to the load at the operational frequency;
calculate the efficiency of the system at the operating frequency, the efficiency being indicative of a quality of the load; and
outputting an indication of the quality.

6. The system of claim 5, wherein the operational frequency is the resonant frequency.

7. The system of claim 1, the system comprising a multiple induction heating coil induction heating system, and wherein the memory further includes program instructions for execution by the processor to:
determine an amount of power coupled to each of the induction heating coils; and
output an indication of the amount of power coupled to each of the induction heating coils.

8. The system of claim 1, further comprising a user interface operatively connected to the controller and configured to receive the indication from the controller and provide a sensory output of the indication.

9. The system of claim 1, wherein the sensory output is a visual or audio indicator.

10. The system of claim 1, wherein the detector comprises a shunt resistor in series with the high frequency source.

11. A method for monitoring the operation of an induction heating system including an induction heating coil for heating loads placed thereon, the method comprising:
monitoring a sensor signal of signal representative of a characteristic of the current through the induction heating coil;
detecting a presence of a load on the induction heating coil from the sensor signal;
detecting an amount of power coupled into the load from the sensor signal;
providing an indication of the amount of power that is coupled to the load.

12. The method of claim 11, further comprising:
detecting one or more positions of the load on the induction heating coil;
detecting the amount of power coupled to the load at each detected position;
determining an optimal placement of the load on the induction heating coil, the optimal placement of the load corresponding to a position where a maximum amount of power is coupled to the load; and
providing an indication of the optimal placement of the load on the induction heating coil.

13. The method of claim 11, further comprising:
operating the induction heating coil at an operational frequency;
determining a quality of the load from a difference between the amount of power coupled to the load at the operational frequency and a maximum output power of the system; and
outputting an indication of the quality of the load.

14. The method of claim 13, further comprising:
determining a resonant frequency of the system and load from the sensor signal;
operating the system at the resonant frequency to determine a quality of the load.

15. The method of claim 10, further comprising:
detecting an amount of power coupled to each load in a multiple induction heating coil induction heating system; and
outputting an indication of the amount of power coupled to each load.
